(19) United States
(12) Patent Application Publication
(10) Pub. No.: US 2025/0266997 A1
(43) Pub. Date: Aug. 21, 2025

(54) METHOD FOR DETERMINING AN ENCRYPTION METHOD FOR VEHICLE COMMUNICATION

(71) Applicant: Robert Bosch GmbH, Stuttgart (DE)

(72) Inventors: Andreas Heyl, Weil Der Stadt (DE); Christian Zimmermann, Stuttgart (DE); Christoph Boesch, Kirchentellinsfurt (DE); Johannes Christian Mueller, Stuttgart (DE); Peter Schneider, Holzgerlingen (DE)

(21) Appl. No.: 19/052,752

(22) Filed: Feb. 13, 2025

(30) Foreign Application Priority Data
Feb. 16, 2024 (DE) 10 2024 201 448.6

(51) Int. Cl. H04L 9/32

(52) U.S. Cl. CPC H04L 9/32

(57) ABSTRACT

A method for determining an encryption method for vehicle communication. The method includes: providing sensor data, wherein the sensor data result from a detection by at least one sensor of a vehicle; ascertaining an environmental model based on the sensor data provided, wherein the environmental model represents an environment of the vehicle; evaluating a current condition for the vehicle communication based on an analysis of the environmental model and an analysis of at least one communication parameter, wherein the at least one communication parameter characterizes a communication with at least one potential communication partner of the vehicle; determining the encryption method for the vehicle communication based on a result of the evaluation. A computer program, a device, and a storage medium, are also described.

### FIELD

The present invention relates to a method for determining an encryption method for vehicle communication. The present invention furthermore relates to a computer program, a device, and a storage medium for this purpose.

### BACKGROUND INFORMATION

At present, safety-critical applications such as vehicles are increasingly networked with external systems, such as cloud or edge systems. It is foreseeable that this networking will go so far that even safety-critical functions and calculations will be moved from the vehicle to the cloud or edge.

Since safety goals with high (A) SILs (Automotive Safety Integrity Level) often cannot be implemented sufficiently well or economically by individual system components, a decomposition concept is typically provided in the safety standards. This allows a safety goal with a high (A) SIL to be decomposed into multiple derived safety goals with a lower (A) SIL when deriving a safety concept. Decomposed safety goals with reduced (A) SIL are allocated to independent system components in the safety concept. The independent system components then implement appropriate safety measures for themselves and thus jointly (i.e., in the component network) fulfill the original safety goal with a high (A) SIL. Details on decomposition according to ISO-26262 can be found, for example, in B. Sari (2019), “Fail-operational Safety Architecture for ADAS/AD Systems and a Model-driven Approach for Dependent Failure Analysis.”Depending on the chosen safety architecture, decompositions can be used in redundancy-based concepts, such as an M-out-of-N comparator, or in so-called monitor-actuator concepts (also called doer-checker) to distribute the safety load between the system components. Details on various common safety architecture patterns of their components can be found, for example, in C. Preschern et. Al (2019), “Safety Architecture Pattern System with Security Aspects.”

When decomposition is carried out, it must be examined in particular whether the independent system components are actually sufficiently independent with regard to the properties required in the safety goal. For this purpose, a so-called dependent failure analysis (DFA) is performed, in which the decomposed components are examined with regard to common causes of failures (e.g., use of the same software implementation when calculating a decomposed function) and cascading failures. If possible failures that can violate the safety goal of multiple decomposition partners simultaneously are identified, suitable countermeasures are derived (e.g., use of a different software implementation in the independent system components) or the decomposition of the safety goal in the overall system is revised. Details on DFA according to ISO-26262 and possible causes of failure can be found, for example, in B. Sari (2019), “Fail-operational Safety Architecture for ADAS/AD Systems and a Model-driven Approach for Dependent Failure Analysis.”

According to the related art, safety analyses of safety-relevant systems (such as the aforementioned DFA) are performed in particular during the development time for a fixed system design. For example, various vehicle-to-everything (V2X) communication standards (e.g., the WLAN variants IEEE 802.11p and IEEE 802.11bd, as well as cellular-sidelink-based LTE-V2X and NR-V2X) are under development, which makes it possible in particular for ADAS and AD systems in vehicles to integrate data and signals from vehicle-external components, such as other vehicles (V2V, vehicle-to-vehicle) or infrastructure elements (V2I, vehicle-to-infrastructure), into their data/signal processing and functionalities. V2X data exchange is usually situation-specific and/or location-based and is implemented wirelessly via so-called ad-hoc connections. An example application is the integration of infrastructure sensor data into (partially) automated driving functions in order to improve environmental perception. Sensor data are transmitted in Europe in so-called collective perception messages (CPMs), in the USA in sensor data sharing messages (SDSMs), and in China in sensor sharing messages (SSMs).

### SUMMARY

The present invention provides a method, a computer program, a device, and a computer-readable storage medium. Features of and details relating to the present invention are disclosed herein. Features and details that are described in connection with the method according to the present invention of course also apply in connection with the computer program according to the present invention, the device according to the present invention, and the computer-readable storage medium according to the present invention, and vice versa in each case, so that mutual reference can also always be made with regard to the disclosure of the present invention.

According to an example embodiment of the present invention, a method for determining an encryption method for vehicle communication, comprising the following steps, wherein the steps can be performed repeatedly and/or successively. Within the framework of vehicle communication, at least one cooperative driving function can be carried out, for example.

In a first step, sensor data are preferably provided, wherein the sensor data result from a detection by at least one sensor of a vehicle. The sensor data can comprise, for example, image data from a camera sensor, radar data from a radar sensor, ultrasound data from an ultrasonic sensor, or LiDAR data from a LiDAR sensor, although other sensor types can also be used.

In a further step, an environmental model is preferably ascertained on the basis of the sensor data provided, wherein the environmental model represents an environment of the vehicle. The environmental model comprises, for example, various objects such as other vehicles, road markings, pedestrians, or similar objects of road traffic. For example, on the basis of the environmental model, a distance to another vehicle can be ascertained and, if necessary, a dangerous situation can be concluded.

In a further step, a current condition for the vehicle communication is preferably evaluated on the basis of an analysis of the environmental model and an analysis of at least one communication parameter, wherein the at least one communication parameter characterizes a communication with at least one potential communication partner of the vehicle. In simple terms, the current condition reflects, for example, whether the analysis of the environmental model indicates that a dangerous situation exists or whether the analysis of the at least one communication parameter indicates that there is a bad or a good connection to the at least one communication partner. The at least one potential communication partner can, for example, be an infrastructure system and/or another vehicle. It is also possible that communication could take place with a pedestrian, for example using the pedestrian's mobile device.

In a further step, the encryption method for the vehicle communication is preferably determined on the basis of a result of the evaluation. Determining the encryption method is in particular determining a type of the encryption method, i.e., what type of encryption method is to be used. Furthermore, it is also possible that at least one parameter for the encryption method is determined, for example a number of iterations of an encryption. The encryption method is determined in particular as part of weighing a current situation on the basis of the environmental model and the present at least one communication parameter. In simple terms, in a safe situation and with sufficiently good conditions with regard to the at least one communication parameter, a more complex encryption method can be determined, which can advantageously provide a higher level of security. An example of the encryption method is a Diffie-Hellman key exchange.

It is also optionally possible that, within the framework of the vehicle communication, a component list of the vehicle is transmitted to the at least one potential communication partner, wherein the method preferably furthermore comprises the following step:
determining safety-relevant components of the vehicle for the transmission of the component list.

By transmitting the component list, it is subsequently advantageously possible to determine, by comparing the component lists, whether common cause failures can occur between the vehicle and the at least one potential communication partner, since common cause failures can occur in particular when the same components are used. The method can thus furthermore comprise the step of comparing the component lists of the vehicle and of the at least one potential communication partner. If the evaluation shows that sufficiently good conditions are in place, which can be determined, for example, on the basis of appropriate threshold values, the step of determining the safety-relevant components can also be performed. This can allow an additional increase in security since not all but only the safety-relevant components are transmitted with the component list. This means that even if the transmitted message is intercepted, only the safety-relevant components can be identified.

Furthermore, according to an example embodiment of the present invention, it can be provided that the encryption method is a private set intersection method, wherein versions, encrypted by the private set intersection method, of the transmitted component lists are compared in order to calculate an intersection. By using the private set intersection method, a high level of security can be guaranteed since the data are transmitted in encrypted form and only the intersection of the data is visible. Examples of private set intersection methods are oblivious transfer, differential privacy, homomorphic encryption, or secure multiparty computation.

Furthermore, according to an example embodiment of the present invention, it is advantageous if the method furthermore comprises the following step:
checking the plausibility of a transmitted communication request for the vehicle communication by the at least one potential communication partner within the framework of the vehicle communication on the basis of an analysis of the environmental model.

The term “checking the plausibility” can also be understood as “verifying.” As part of the plausibility check, it can be determined, for example, whether a critical driving situation that would justify a less secure encryption method actually exists. This can advantageously prevent a cyberattack that only feigns or falsely indicates a critical driving situation.

According to an example embodiment of the present invention, it is also advantageous if, within the scope of the present invention, the analysis of the environmental model with regard to a driving situation of the vehicle and/or a time-criticality of the driving situation of the vehicle is performed as part of the evaluation of the current condition. For example, the driving situation may indicate that a collision between the vehicle and the at least one communication partner is possible. In this case, the vehicle communication may be particularly time-critical and a less complex encryption method or even no encryption method at all may be used accordingly.

Advantageously, the present invention can provide that the at least one communication parameter is a signal quality and/or a transmission latency between the vehicle and the at least one potential communication partner within the framework of the vehicle communication. This makes it advantageously possible to evaluate whether the vehicle communication with the at least one potential communication partner makes sense, since failures can occur if the signal quality and/or transmission latency is poor. It can thus also be provided that, if the signal quality and/or transmission latency is good enough, for which a threshold value can be defined in each case, a more complex encryption method can be used.

According to an example embodiment of the present invention, it may furthermore be possible that the evaluation of the current condition is also performed on the basis of an expected benefit of at least one cooperative driving function within the framework of the vehicle communication. The expected benefit is determined, for example, by a heuristic or learned with the help of a neural network. An example of cooperative driving functions is automated merging into traffic on the freeway. Another example is cooperative braking, in which vehicles communicate with one another in order to avoid a collision. Cooperative overtaking, in which one vehicle makes it possible for another vehicle to overtake, can also be an example of cooperative driving functions.

According to an example embodiment of the present invention, it is possible for the method according to the present invention to be used in a vehicle. The vehicle may be configured, for example, as a motor vehicle and/or passenger vehicle and/or autonomous vehicle. The vehicle may comprise a vehicle mechanism, for example for providing an autonomous driving function and/or a driver assistance system. The vehicle mechanism may be designed to at least partially automatically control and/or accelerate and/or brake and/or steer the vehicle.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for processing data that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be carried out as a computer-implemented method.

Further advantages, features and details of the present invention can be found in the following description, in which exemplary embodiments of the present invention are described in detail with reference to the figures. The features mentioned herein can be essential to the present invention, individually or in any combination.

### BRIEF DESCRIPTION OF THE DRAWINGS

FIG. 1 is a schematic visualization of a method, a vehicle having a sensor, a device, a storage medium, and a computer program according to exemplary embodiments of the present invention.

FIG. 2 is a schematic representation of a method according to exemplary embodiments of the present invention.

### DETAILED DESCRIPTION OF EXAMPLE EMBODIMENTS

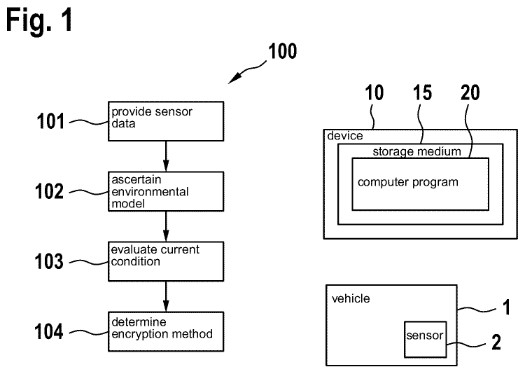

FIG. 1 schematically shows a method 100, a vehicle 1 having a sensor 2, a device 10, a storage medium 15, and a computer program 20 according to exemplary embodiments of the present invention.

FIG. 1 in particular shows a method 100 for determining an encryption method 5 for vehicle communication 3. In a first step 101, sensor data are provided, wherein the sensor data result from a detection by at least one sensor 2 of a vehicle 1. In a second step 102, an environmental model 4 is ascertained on the basis of the sensor data provided, wherein the environmental model 4 represents an environment of the vehicle 1. The environmental model 4 can be calculated by an appropriate processor of the vehicle 1, for example an on-board computer. In a third step 103, a current condition for the vehicle communication 3 is preferably evaluated on the basis of an analysis of the environmental model 4 and an analysis of at least one communication parameter, wherein the at least one communication parameter characterizes a communication with at least one potential communication partner 6 of the vehicle 1. The evaluation can also be performed by the appropriate processor of the vehicle 1. In a fourth step 104, the encryption method 5 for the vehicle communication 3 is determined on the basis of a result of the evaluation 103, wherein the determination can also be performed by the appropriate processor of the vehicle 1.

In order to reduce the safety load of individual nodes in distributed systems, it is advisable, for example, to distribute safety-relevant functions redundantly across different nodes. In order to avoid common cause failures in the DFA, component lists can be compared first in an ad hoc configured distributed system. If the distributed system has modules of different manufacturers and competitors, open communication of these module lists may be undesirable since this would communicate subsystem internals. In particular in the context of networked automated driving, the disclosure of the manufacturer-specific, internally used SW/HW components etc. to every possible interaction partner, which is necessary for a DFA, can represent a major hurdle for the use of data and signals, provided via V2X, in safety-relevant applications. This is because such detailed component lists can allow conclusions to be drawn about the design and possibly even the cost structure of competitor products. A method for comparing the components and module list must therefore preferably ensure that the specific components remain confidential during the comparison.

One way to achieve such a comparison is to use encryption methods, in particular private set intersection (PSI) methods. However, there is a trade-off when selecting such a method: The methods that work particularly quickly can represent a significant hurdle for spying on the component and module list but can be attacked with appropriate effort with the promise of success. Methods that offer higher security, on the other hand, are correspondingly more complex and require more time to implement. However, especially in critical traffic situations, this time is often not available.

According to exemplary embodiments, the present invention therefore provides a method which resolves the trade-off between fast, less secure and complex but slow encryption methods, in particular PSI methods, depending on the situation.

For example, the criticality of a driving situation is taken into account. The more time-critical the control of the driving situation is, the less time is available to, for example, exchange a component or module list and subsequently carry out a cooperative driving function. An expected start-up time of the cooperative driving function can accordingly represent a boundary condition that excludes the use of time-consuming encryption methods, in particular PSI methods, in time-critical situations. According to exemplary embodiments, the method according to the present invention therefore automatically weighs the expected benefit of a cooperative driving function against a risk that sensitive information will be revealed. When weighing, traffic safety is prioritized over confidentiality of a system configuration, for example. According to the weighing, the most suitable encryption method, in particular PSI method, is preferably selected in order to ensure protection, for example of component or module lists, that is appropriate for the driving situation and the time-criticality of the driving situation, or the cooperative driving function can be dispensed with entirely.

In order to prevent or make downgrade attacks more difficult, the current driving situation criticality and time criticality of the driving situation can be checked for plausibility by the requested communication partner via the ego sensor system. For example, in a scenario in which an attacking vehicle A requests a component or module list comparison from a vehicle B using a fast and less secure encryption method, in particular PSI method, vehicle B can use its ego sensors (e.g., radar, camera, lidar), which observe its surroundings, to evaluate whether vehicle A is actually in a potentially critical and time-critical driving situation (e.g., on a collision course that requires emergency braking) or whether the driving situation appears normal or non-critical or non-time-critical and the less secure encryption method, in particular PSI method, is unjustified.

Furthermore, V2X channel properties can be taken into account. In V2X connections, the signal quality can strongly correlate with the spatial distance between the communication partners. The higher the transmission latency and/or the poorer the signal quality, the less likely it is, for example, that the intended cooperative driving function will actually be available later, since a connection loss can be expected. Accordingly, the expected benefit may decrease in comparison to the risk of a confidentiality breach and the method according to the present invention prioritizes, according to exemplary embodiments, strong protection of confidentiality over fast availability of the driving function. In particular, the intended cooperative driving function should not carry a particularly high safety load in such a driving situation anyway, since low reliability can be expected due to the expected connection loss.

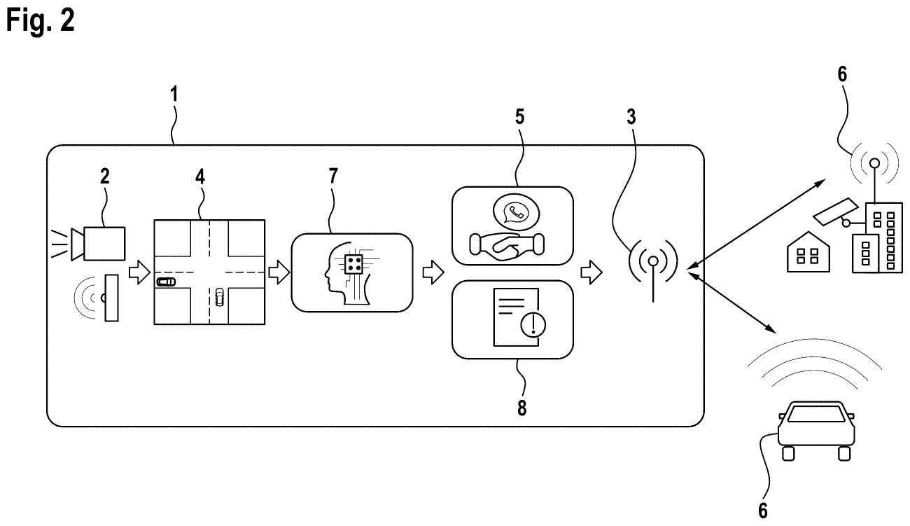

FIG. 2 shows a sequence of the method according to exemplary embodiments. The situation analysis 7, which evaluates a current condition for the vehicle communication 3, preferably obtains an environmental model 4, which can be constructed from sensor data of at least one sensor of the vehicle 2 as input. In addition, a situation analysis module for the situation analysis 7 can obtain information about a system state with respect to at least one communication parameter, such as the strength of available V2X connections and the channel properties of the connections. From the environmental model 4, the situation analysis 7 can determine the criticality of the situation and in particular times within which an intended cooperative driving function must be available in order to achieve the planned benefit.

On the basis of the time and criticality evaluation of the current situation, a selection module assigns costs in particular to the available encryption methods 5, preferably PSI methods, and selects the encryption method 5 that appears overall to be the most suitable for the current situation. The cost weighting takes into account, for example, the driving situation criticality and the V2X channel properties. Furthermore, the expected benefit of the cooperative driving function in comparison to a comparable driving function without V2X communication can be taken into account in the cost weighting. According to exemplary embodiments, the expected benefit is determined by a heuristic or learned with the help of a neural network.

Furthermore, according to step 8 in FIG. 2, relevant components for the transmission of the component list can be determined.

Subsequently, the vehicle communication 3 with at least one potential communication partner 6 can be established, for example in order to carry out a cooperative driving function.

The V2X communication can be carried out with intelligent infrastructure or with other networked vehicles. The networked vehicle can act as a user of cooperative driving functions and also provide data that are used by others, in particular other networked vehicles, for example for cooperative driving functions. If the vehicle itself has no benefit but only helps others, the vehicle will in most cases insist on a particularly secure PSI method. An exception in this respect is emergency assistance to others if they would be put in a precarious or even dangerous situation as a result of a slower PSI method.

Before the actual PSI component comparison can take place, the communication partners involved must first agree on a PSI protocol. In favorable exemplary embodiments, the available PSI methods are standardized so that a comparison of the available protocols by message exchange is not necessary.

With regard to carrying out the cost evaluation and the heuristics for selecting the PSI method, a variety of exemplary embodiments are possible. In some embodiments, the cost evaluation is performed explicitly in the form of a cost function. Other embodiments use artificial neural networks to learn the cost evaluation and in particular associated heuristics from a data set.

In some exemplary embodiments, the PSI method is negotiated using auctions (auction-based). Alternatively, the PSI method can also be determined by the initiator of the communication, wherein the communication partner(s) can accept or reject the communication or make a counterproposal for a different PSI method.

The above description of the embodiments describes the present invention exclusively in the context of examples. Of course, individual features of the embodiments, provided they make technical sense, can be freely combined with one another without departing from the scope of the present invention.

1-10 (canceled)

11. A method for determining an encryption method for vehicle communication, the method comprising the following steps:
providing sensor data, wherein the sensor data result from a detection by at least one sensor of a vehicle;
ascertaining an environmental model based on the provided sensor data, wherein the environmental model represents an environment of the vehicle;
evaluating a current condition for the vehicle communication based on an analysis of the environmental model and an analysis of at least one communication parameter, wherein the at least one communication parameter characterizes a communication with at least one potential communication partner of the vehicle; and
determining the encryption method for the vehicle communication based on a result of the evaluation.

12. The method according to claim 11, wherein, within the framework of the vehicle communication, a component list of the vehicle is transmitted to the at least one potential communication partner, and wherein the method further comprises the following step:
determining safety-relevant components of the vehicle for the transmission of the component list.

13. The method according to claim 12, wherein the encryption method is a private set intersection method, wherein versions, encrypted by the private set intersection method, of the transmitted component lists are compared in order to calculate an intersection.

14. The method according to claim 11, the method further comprising the following step:
checking plausibility of a transmitted communication request for the vehicle communication by the at least one potential communication partner within the framework of the vehicle communication based on the analysis of the environmental model.

15. The method according to claim 11, wherein the analysis of the environmental model with regard to a driving situation of the vehicle and/or a time-criticality of the driving situation of the vehicle is performed as part of the evaluation of the current condition.

16. The method according to claim 11, wherein the at least one communication parameter is a signal quality and/or a transmission latency between the vehicle and the at least one potential communication partner within the framework of the vehicle communication.

17. The method according to claim 11, wherein the evaluation of the current condition is also performed based on an expected benefit of at least one cooperative driving function within the framework of the vehicle communication.

18. A device configure to process data, the device configured to determine an encryption method for vehicle communication, the device configured to:
provide sensor data, wherein the sensor data result from a detection by at least one sensor of a vehicle;
ascertain an environmental model based on the provided sensor data, wherein the environmental model represents an environment of the vehicle;
evaluate a current condition for the vehicle communication based on an analysis of the environmental model and an analysis of at least one communication parameter, wherein the at least one communication parameter characterizes a communication with at least one potential communication partner of the vehicle; and
determine the encryption method for the vehicle communication based on a result of the evaluation.

19. A non-transitory computer-readable storage medium on which are stored commands for determining an encryption method for vehicle communication, the commands, when executed by a computer, causing the computer to perform the following steps:
providing sensor data, wherein the sensor data result from a detection by at least one sensor of a vehicle;
ascertaining an environmental model based on the provided sensor data, wherein the environmental model represents an environment of the vehicle;
evaluating a current condition for the vehicle communication based on an analysis of the environmental model and an analysis of at least one communication parameter, wherein the at least one communication parameter characterizes a communication with at least one potential communication partner of the vehicle; and
determining the encryption method for the vehicle communication based on a result of the evaluation.
